(19) United States
(12) Patent Application Publication
(10) Pub. No.: US 2026/0241551 A1
(43) Pub. Date: Aug. 20, 2026

(54) PRE-TRAINING AUTO-REGRESSIVE ROBOTIC MODELS WITH 4D REPRESENTATIONS

(71) Applicant: THE REGENTS OF THE UNIVERSITY OF CALIFORNIA, Oakland, CA (US)

(72) Inventors: Trevor Darrell, Berkeley, CA (US); Dantong Niu, Berkeley, CA (US); Yuvan Sharma, San Jose, CA (US); Haoru Xue, San Francisco, CA (US); Junyi Zhang, Berkeley, CA (US); Ziteng Ji, Berkeley, CA (US)

(21) Appl. No.: 19/539,588

(22) Filed: Feb. 13, 2026

Related U.S. Application Data
(60) Provisional application No. 63/758,676, filed on Feb. 14, 2025.

(51) Int. Cl. B25J 9/16

(52) U.S. Cl. CPC B25J 9/1612; B25J 9/1664

(57) ABSTRACT

A robotic system includes a robot, and one or more processors configured to execute code that cause the one or more processors to: estimate four-dimensional representations from videos, operate a machine learning transformer model to use information from the four-dimensional representation for training and testing a policy for predicting a next action for the robot, and use the machine learning transformer model with the robot.

### CROSS-REFERENCE TO RELATED APPLICATIONS

This disclosure is a non-provisional of and claims benefit from U.S. Provisional Patent Application No. 63/758,676, filed Feb. 14, 2025, titled “PRE-TRAINING AUTO-REGRESSIVE ROBOTIC MODELS WITH 4D REPRESENTATIONS,” the disclosure of which is incorporated herein by reference in its entirety.

### TECHNICAL FIELD

This disclosure relates to foundation models for robots, more particular to foundation models that use 3D video data over time for four dimensions.

### BACKGROUND

Foundation models pre-trained on massive unlabeled datasets have revolutionized natural language and computer vision, exhibiting remarkable generalization capabilities, thus highlighting the importance of pre-training. Yet, efforts in robotics have struggled to achieve similar success, limited by either the need for costly robotic annotations or the lack of representations that effectively model the physical world.

Recently, foundation models (FMs) have shown remarkable success, particularly in the domains of language, vision, and multi-modal models pre-trained on vast amounts of vision and text data. These models exhibit impressive zero-shot and few-shot learning capabilities, highlighting the power of pre-training on generic data. However, numerous attempts in robotics have yet to achieve the same pre-training success seen in other domains. This could potentially be attributed to the scarcity of large-scale, diverse robotic data, unlike the abundance of text and image data available for vision and language FMs.

The lack of robotic data poses a significant bottleneck in training foundation models that can effectively generalize across diverse robotic platforms and tasks. To overcome this limitation, several recent approaches employ representation learning by pre-training on an abundance of human data, enabling transfer to robotic systems. These approaches aim to recognize the inherent similarities between human and robot manipulation tasks and exploit the vast repositories of human video data available on the internet. Yet, these approaches have not been able to demonstrate effective generalization to downstream tasks. In part, this is due to their representations lacking an understanding of the physical world, and therefore being less effective for robotics.

In contrast with these methods, Vision-Language-Action (VLAs) models take a slightly different approach, implicitly leveraging human data in robotics by incorporating pre-trained components from Vision-and-Language Models (VLMs). In particular, they use language decoders pre-trained on tasks like visual question answering. Despite such efforts, there is a discrepancy between these models' high-level pre-training objective and the goal of enabling robotic models to handle low-level action prediction. While these initial objectives are valuable for comprehending visual and linguistic content, they do not directly address the nuances of low-level robot control, which involves aspects like precise manipulation and spatial reasoning.

### BRIEF DESCRIPTION OF THE DRAWINGS

FIGS. 1A-1D show captured video images and corresponding three-dimensional (3D) point tracking images.

FIG. 1E shows an embodiment of an Auto-regressive Robotic Model that leverages low-level 4D Representations (ARM4R).

FIG. 2 shows a diagram of an embodiment of a training process for ARM4R.

FIG. 3 shows results of an ablation study for two stages of training of an embodiment of a robotic model.

FIGS. 4A-4H shows captured video images and corresponding 3D point tracking on randomly chosen kitchens in out-of-domain human videos.

FIGS. 5A-5L shows photographs and corresponding 3D point tracking images of an embodiment of 3D point tracking on randomly chosen kitchens for in-domain Kinova robot and an out-of-domain Open X-Embodiment robot.

FIG. 6 shows a photograph of an experimental setup of a Kinova robot.

FIGS. 7A-7H show photographs of configurations and variations of tasks for a Kinova robot.

FIG. 8 shows a photograph of an experimental setup for tasks for a Franka robot.

### DETAILED DESCRIPTION OF THE EMBODIMENTS

The embodiments here introduce ARM4R, an Auto-regressive Robotic Model that leverages low-level 4D Representations (ARM4R) learned from human video data to yield a better pre-trained robotic model. Specifically, the embodiments focus on utilizing 3D point tracking representations from videos derived by lifting 2D representations into 3D space via monocular depth estimation across time. These 4D representations maintain a shared geometric structure between the points and robot state representations up to a linear transformation, enabling efficient transfer learning from human video data to low-level robotic control. Experiments show that ARM4R can transfer efficiently from human video data to robotics and consistently improves performance on tasks across various robot environments and configurations.

To address the issues discussed above, the method of the embodiments employs a lower-level pre-training objective by starting with a model that utilizes next-token prediction to learn 4D representations from human video data. These representations can then be transferred to more specialized scenarios by fine-tuning on robotic scenes and subsequently on proprioceptive data, while maintaining the same training objective. As used herein, the term “pre-training” means training a model to learn general patterns, language structure, and general knowledge that allows the pre-trained model to be adapted for specific tasks.

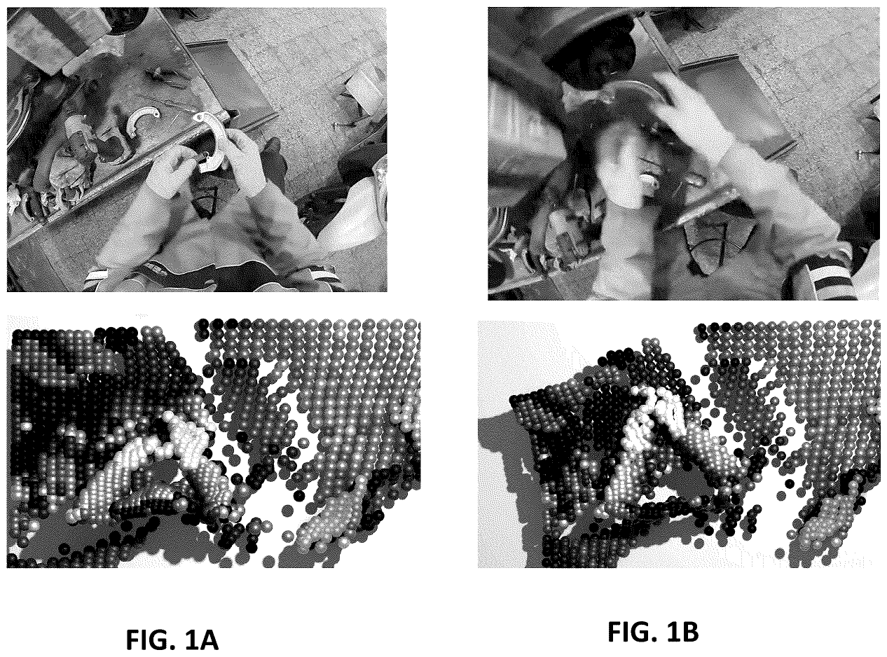

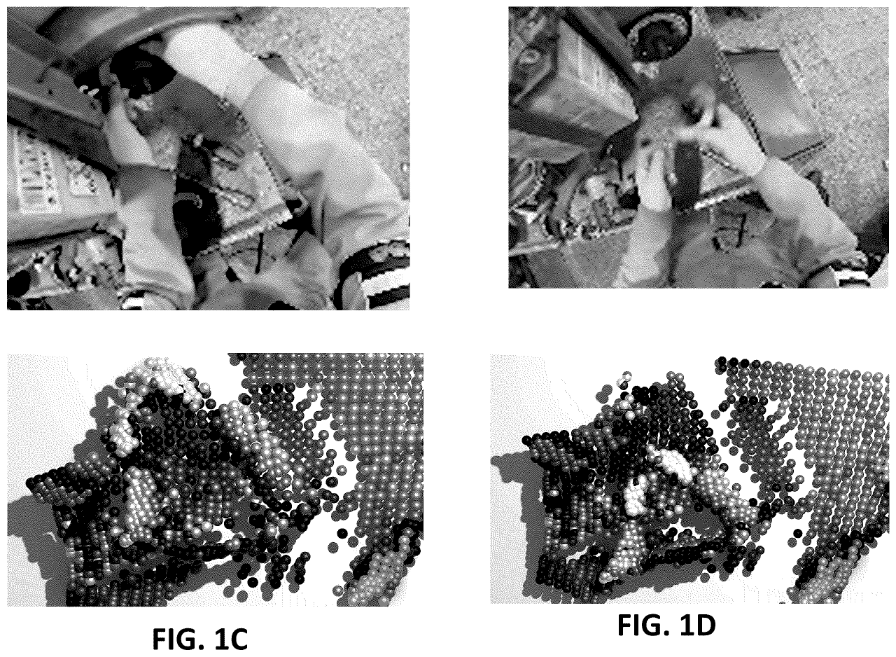

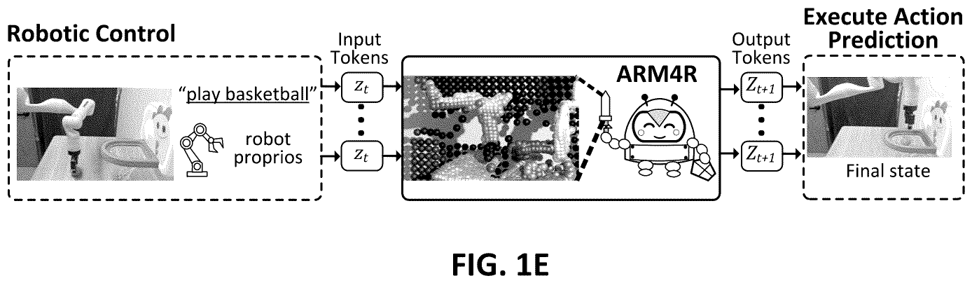

FIGS. 1A-1D show examples of monocular human videos on the top of each figure, with the 3D point tracks prediction on the bottom of each figure. FIG. 1E shows a diagram of overall robotic control. The ARM4R model receives the input tokens of the motion and then generates output tokens to produce a final state of the robot and the corresponding action.

The key insight behind ARM4R is to learn a low-level representation from the abundance of human video data that can capture properties of the physical world. This involves lifting 2D representations to 3D using monocular depth estimation and subsequently tracking the 3D points. The resulting 4D representations maintain a shared geometric structure, up to a linear transformation, between the 3D points and robot state representations used downstream, enabling efficient transfer learning from human video data to robotic manipulation tasks. Surprisingly, pre-training the method of the embodiments solely on human data yields superior results compared to other models like VLAs that are pre-trained on robotic data such as OpenX.

The embodiments include several new elements. They introduce a novel robotics pre-training approach that incorporates low-level 4D representations that enhance understanding of the physical world while also learning from unlabeled videos. The embodiments show that pre-training solely on human video data can lead to better performance than other methods that are pre-trained only on robotic data. The method of the embodiments on average surpasses baselines like Per-Act on 12 different tasks in RL-Bench's simulated environment, and OpenVLA on real tasks with a 7-DoF Kinova Gen3 robot. The model used in the embodiments also exhibits several advantageous properties, including cross-robot generalization and 3D point track prediction for out-of-domain human and robotic videos. The embodiments involve a robotic system that uses a mechanism for estimating four-dimensional representations from videos, and a machine learning transformer model that uses information from the four-dimensional representation for training and testing a policy.

Visual-Language-Action models (VLAs) are a type of robotic model that combines visual perception, language understanding, and action generation capabilities. VLAs take as input visual observations along with a language instruction and output a sequence of robot control actions. Several VLAs, such as LLARVA, Open-VLA, LLaRA, and RoboPoint directly fine-tune a VLM (Visual-Language Model), a foundation for VLAs, to predict robot actions, often using special tokens to represent the action space. These models differ in the choice of VLM, and the specific method used to encode robot actions, but they share the underlying principle of adapting a pretrained VLM for robotic control. A similar model is 3D-VLA, which consists of components for generating future states of an environment based on data that includes 3D information, such as point clouds. These existing VLAs utilize language decoders that have been pre-trained for high-level tasks like image captioning and VQA, which may be inadequate for low-level robotic environments. In contrast, the embodiments show that leveraging low-level vision representations from human video data can result in a better pre-trained robotic model.

Motion estimation spans from 2D optical flow and object tracking to recent dense point tracking. Moving from 2D to 3D further enriches the geometric understanding. Early work on scene flow estimates short-term 3D motion based on explicit 3D structure or depth images. More recently, SpatialTracker tackles long-range 3D point tracking by lifting 2D pixels into 3D with monocular depth estimates and iteratively refining 3D trajectories with as-rigid-as-possible motion priors. This 3D-driven strategy greatly improves occlusion robustness and yields impressive 3D point tracking results.

The embodiment converts the 2D image into 3D using a monocular depth estimation software. Alternatively, a regressive model may be used. Models such as DUSt3R (Dense Unconstrained Stereo 3D Reconstruction) are state-of-the-art AI models that revolutionized 3D scene reconstruction by treating it as a pointmap regression problem, rather than relying on complex, traditional camera calibration (Structure from Motion) and/or tracking models. It uses transformers to predict 3D point clouds directly from unposed image pairs, generating dense depth and 3D structure for arbitrary images.

A model released previously by UC Berkeley and co-authors extended this paradigm to 4D, entitled “St4RTrack: Simultaneous 4D Reconstruction and Tracking in the World”. Given an RGB video capturing dynamic scenes, St4RTrack simultaneously tracks the points from the initial frame (visualized in blue) and reconstructs the geometry of the subsequent frames (in red) in a consistent world coordinate. St4RTrack is a feed-forward framework that takes a pair of images and outputs two pointmaps in the world frame. By iteratively processing the first frame paired with each other frame, St4RTrack achieves simultaneous tracking and reconstruction for the entire video.

In robot learning, 2D motion fields have been used to enable fine-grained control, guiding manipulation and imitation learning. Despite their success, these approaches remain limited by the lack of geometric cues and less spatial awareness. In contrast, 3D motion fields offer more spatially grounded representations, enabling more efficient policy learning. ToolFlowNet leverages scene flow to estimate tool trajectories in behavior cloning, though it uses only a relatively coarse 3D signal. The embodiments instead adopt dense 3D point tracking on diverse human videos and use these rich 4D representations to pre-train a general auto-regressive robotic model with robust and versatile action generation.

Pre-training has emerged as a crucial technique for improving the performance and generalization capabilities in robotics. Large-scale datasets such as OpenX contain diverse sensor modalities, tasks, and action spaces across various robots. Models trained with these datasets, such as RT-1-X, RT-2-X, Octo, OpenVLA and LLARVA, can be applied in various robot embodiments and tasks. Yet, these robot pre-training datasets are still orders of magnitude smaller than the data that current LLMs and VLMs are trained on.

To address the data issue, another prominent pre-training approach is to leverage large-scale datasets of human videos. This harnesses the abundance of freely available human activity data on the internet, offering a scalable alternative to collecting expensive robot demonstrations. For example, Track2Act trains a 2D point-tracking model on human videos from Epic-Kitchens100 and Something-Something-v2, then repurposes it to guide robotic manipulation. Any-Point Trajectory Modeling (ATM) similarly utilizes a small set of human demonstrations to aid cross-embodiment transfer, though in a more task-specific setting and still relying on 2D motion. By contrast, the approach of the embodiments lifts 2D observations into 4D representations (3D plus time), which not only enhances spatial awareness and occlusion handling, but also allows pre-training on human videos at scale, providing broader applicability and more robust policy learning in robotics.

To address the challenge of leveraging pre-trained vision representations from human video in robotic models, the embodiments present an auto-regressive model that relies on low-level 4D representations. The model is trained in three stages. The first stage, the pre-training stage, focuses on learning generalized low-level representations through 3D point tracking from human videos. In the second stage, the model is fine-tuned for the same task but using a small amount of data for the robot that is intended to be used in downstream tasks. Finally, the third stage fine-tunes the model for robotic control.

The 4D representations result from solving the 3D point tracking problem, which involves finding the 3D coordinates of discrete points across time, given a monocular video consisting of T discrete frames. Formally, the objective is to find pₜ as defined below:

$${p}_{t} = \{ ( {x}_{jt} , {y}_{jt} , {z}_{jt} ) \vert 0 \leq j < n \} \qquad ( 1 )$$

Where n is the total number of points being tracked and 0≤t<T. In solving this tracking problem, the identities of the points are fixed and consistent across all frames: the j-th point in pₜ refers to the same physical point in 3D space across all time steps, t∈[0, T). To initialize these points, the methods of the embodiments define a square grid of size g×g on the first frame, frame t=0, resulting in n=g² points. The embodiments track the 3D coordinates of these initial queried n points through the video while maintaining their unique identities.

Robotic control can be formulated as a finite-horizon Markov Decision Process (MDP), characterized by temporal sequences that capture the robot completing a particular task. The task is described by the language instruction l. The temporal sequences typically consist of visual observations i_{0:T-1} and proprioceptive states s_{0:T-1}, which can lie in Cartesian space or joint position space. Then, the objective is to learn a policy that predicts one or more future actions, conditioned on a finite number of previous timesteps, to successfully complete a given task. The term “policy” as used here means a strategy or rulebook that the model has been trained to execute to map states or situations to actions.

Given any video, the models' input is structured at timestep t, into three parts: the language instruction l, the image input iₜ, and the current 3D coordinates of the tracked points, pₜ. These elements together provide the contextual, visual, and spatial information necessary for 3D point tracking. The output is the future 3D coordinates of the tracked points, pₜ₊₁. When fine-tuning the model for robotic control, the language and image inputs maybe the same language and image inputs used in the initial training, or second inputs, and tracked input points are replaced with the robot's current state sₜ, and the output points with the next state, sₜ₊₁. The shared geometric structure, up to a linear transformation, between the points and robot state representations enables efficient transfer learning between the second and third stages.

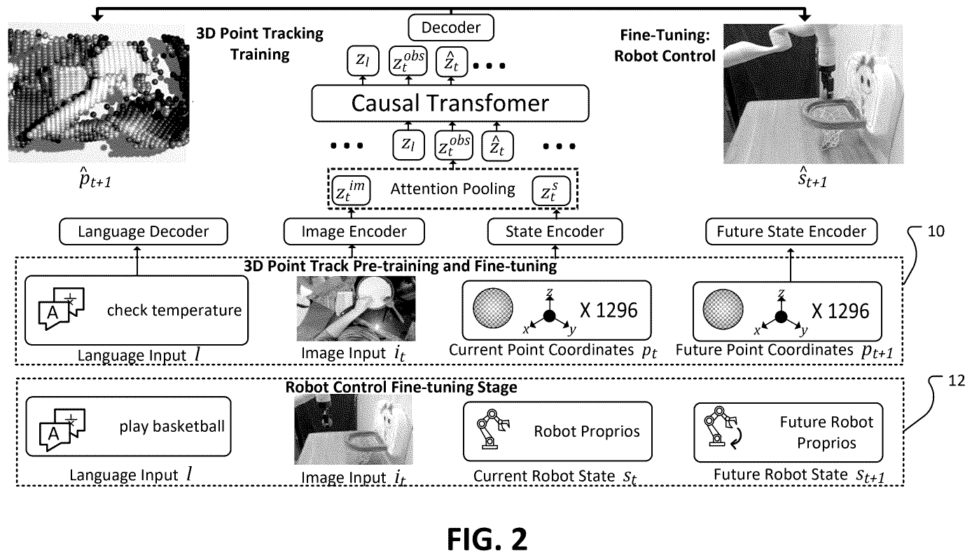

FIG. 2 shows an overview of the overall process. The training has three stages. The first two stages focus on learning a scene-wide 4D representation by predicting 3D points across time, shown in the top box 10. Stage 1 shown in the first two boxes involve pre-trains on a large egocentric human data set, such as Epic-Kitchens100. Stage 2 fine tunes on a smaller dataset, approximately 1-2K demonstrations in one embodiment, of robotic scenes, adapting the point tracking to robotic scene and camera. The model is fine tuned in the second box 12 to predict robot proprioceptive states rather than 3D points.

In the first and second training stages, the objective is to develop an auto-regressive model π capable of predicting 3D point tracks. The predictions are conditioned on the input (l, iₜ, pₜ) from a context window of C timesteps:

$$π ( l , {i}_{t - C + 1 : t} , {p}_{t - C + 1 : t} ) \to {p}_{t + 1} \qquad ( 2 )$$

During control fine-tuning, the objective changes slightly, as the model conditions on, and predicts proprioceptive states:

$$π ( l , {i}_{t - C + 1 : t} , {s}_{t - C + 1 : t} ) \to {s}_{t + 1} \qquad ( 3 )$$

Before being fed into the causal transformer for next-token prediction, each part of the input and output must be processed and projected into the same latent space. To achieve this, separate encoders are used for the language, image, points, and robot states, as discussed below.

A frozen CLIP (Contrastive Language-Image Pre-Training model) text encoder trained on LAION-2B was used as a language encoder to process text, with a learnable linear projection layer added at the end to get the language token zₗ.

To process the image, the inventors used a standard Vision Transformer to get the image token

$${z}_{t}^{im} .$$

This ViT is frozen while training the model and is pre-trained using CrossMAE on a combination of ImageNet and the OpenX dataset. This enables the vision transformer to learn to encode both nonrobotic and robotic data, which is important since the pre-training stage emphasizes the former, while fine-tuning targets the latter.

A standard 2-layer MLP (Machine Learning Perceptron) was used to encode the point coordinates. An MLP generally comprises a feed-forward artificial neural network The resulting feature

$${z}_{t}^{pts}$$

(point z location at time t) is combined with

$${z}_{t}^{i m}$$

(image at point z at time t) via an attention pooling layer to get the current observation token,

$${z}_{t}^{o b s} .$$

A separate MLP is used to encode the next timestep's point coordinates and get \hat{z}ₜ.

For each timestep, three tokens were obtained, one each for language, current visual observation, and prediction, which are fed into the transformer. The implementation used a randomly initialized causal Transformer (ViT-Base). The Transformer is trained for standard next-token prediction on the sequence

$$( {z}_{l} , {z}_{t}^{o b s} , {\hat{z}}_{t} , {z}_{l} , {z}_{t + 1}^{o b s} , {\hat{z}}_{t + 1.} … )$$

with loss only being calculated for \hat{z}ₜ. During inference, the process input

$$( {z}_{l} , {z}_{t}^{o b s} )$$

at timestep 0, and the model predicts \hat{z}ₜ for every timestep.

The loss is calculated using only \hat{z}ₜ, as predicting zₗ and

$${z}_{t}^{o b s}$$

is not the objective in either 3D point tracking or robotic control tasks. The predicted token is decoded using a two-layer MLP into the predicted point tracks \hat{p}ₜ₊₁. The L₁ distance between \hat{p}ₜ₊₁ and pₜ₊₁* is used as the final loss:

$$ℒ ( {\hat{p}}_{t + 1} , {p}_{t + 1} ) = \frac{1}{n} ‖ {\hat{p}}_{t + 1} - {p}_{t + 1}^{*} ‖ 1 \qquad ( 4 )$$

One should note that when fine-tuning for robotic control, the process replaced the MLPs for processing points pₜ with similar MLPs for processing robot states sₜ. Additionally, processing multiple images in the fine-tuning stage, the observation tokens were combined by concatenating linear transforms of the different views to get a single

$${z}_{t}^{o b s}$$

token. The model is also trained to predict multiple future proprioceptive states. The rest of the architecture is kept the same (e.g., loss function). This is discussed in more detail below regarding the implementation, architecture, and training recipes.

As previously mentioned, ARM4R is trained in three stages: the first two stages focus on the 3D point tracking task for human and robot videos respectively, and the last stage focuses on robotic control, shown in FIG. 1.

In the pre-training stage using human videos (Stage 1), the process focuses on learning 3D point tracking, since this task allows the model of the embodiments to leverage large-scale human video data with a representation that also transfers over to the robotic domain. Specifically, the model was trained on 76K videos from the Epic-Kitchens100 dataset (Damen et al., 2018), which contains rich human-object interactions with 97 verbs and 300 noun classes. By training to predict 3D point tracks for such large-scale human data, ARM4R gains a deeper understanding of the spatial dynamics and physical interactions of different bodies and objects, knowledge that is critical for enhancing robotic models.

To extract pseudo-annotations for 3D point tracks, an off-the-shelf tracker that generates 3D tracks for points arranged on a g×g grid was used. Points on the grid are initialized in the first frame of the video and tracked throughout the sequence. One should note that the pseudo-labeled tracks are generated in the camera coordinate frame, inherently capturing both object and camera motion due to the egocentric nature of the human videos. In contrast, the robotic applications of the embodiments typically involve stationary cameras and different object-hand interaction patterns, introducing discrepancies in both camera dynamics and embodiment. To reconcile these differences and ensure smooth transfer to robotic domains, the embodiments introduce a fine-tuning stage focusing on 3D point tracking in the downstream robotic setup.

After the pre-training stage on human video data, the next stage fine-tunes ARM4R for the same 3D point tracking task with videos from the robotic setup used in the downstream application (Stage 2). One should note that this fine-tuning only needs to be performed once for every robot setup for all tasks combined, with a modest amount of data (≈5-10% compared to Stage 1). This step helps transition from the camera dynamics and embodiment gaps between the human video pre-training and the control fine-tuning in the next stage.

Having trained the model on 3D point tracking, the model then undergoes fine-tuning (Stage 3) for robotic control. In this stage, robotic demonstrations depending on the downstream tasks were collected. One should note that this used significantly fewer demonstrations for real robotic tasks than other baselines, discussed below with regard to the experimental setup. After collecting successful data of the robot performing the target task, the current and predicted point tracks in the training process were replaced with current and predicted robot states.

The inventors evaluated ARM4R on 12 tasks in RLBench (James et al., 2020) and compare to relevant 2D and 3D baselines. The model was also tested and ablated on two real robots: a 7-DoF Kinova Gen3 robot (“Kinova”), and a 7-DoF Franka Emika Panda (“Franka”) robot.

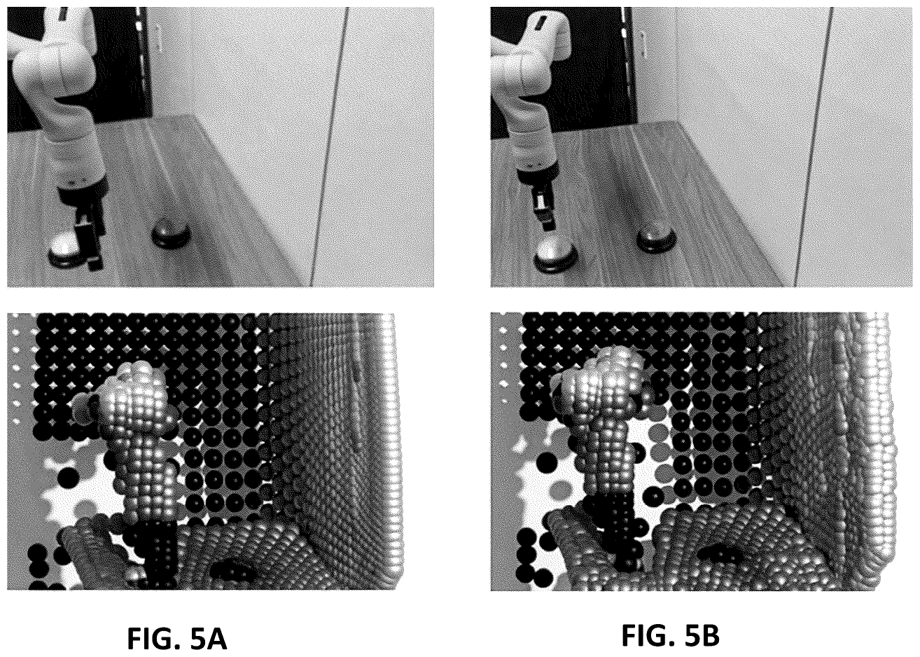

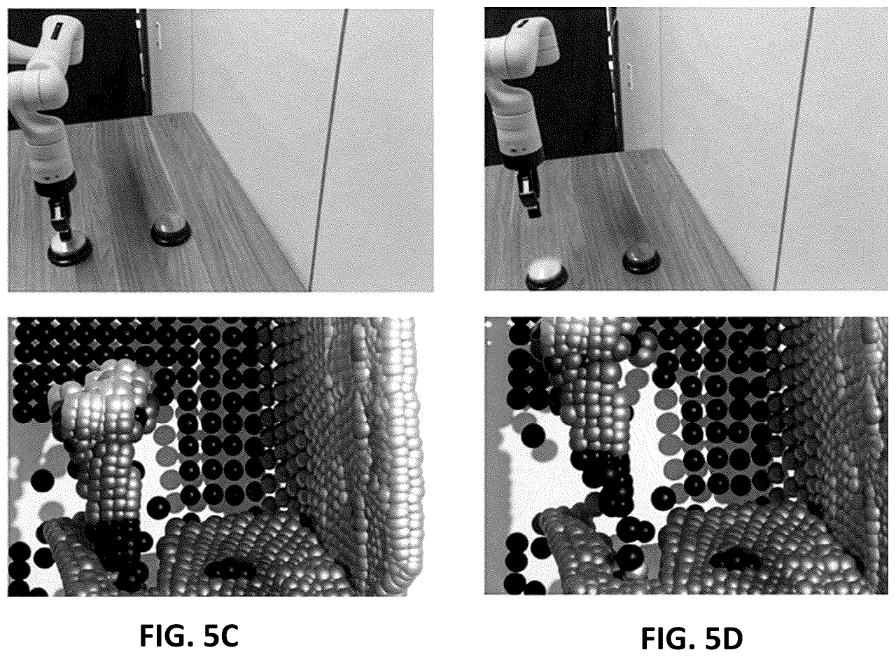

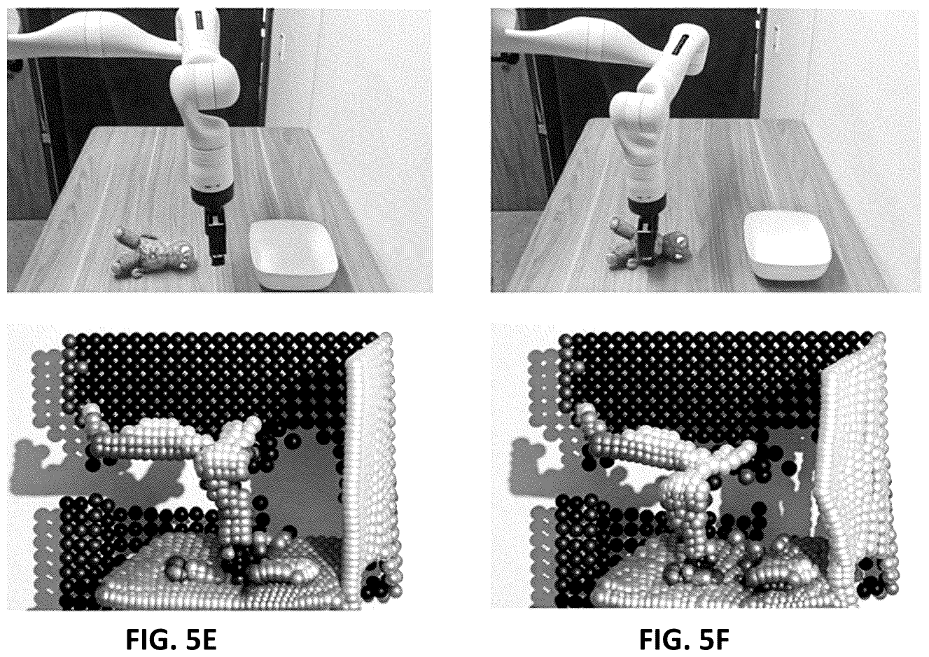

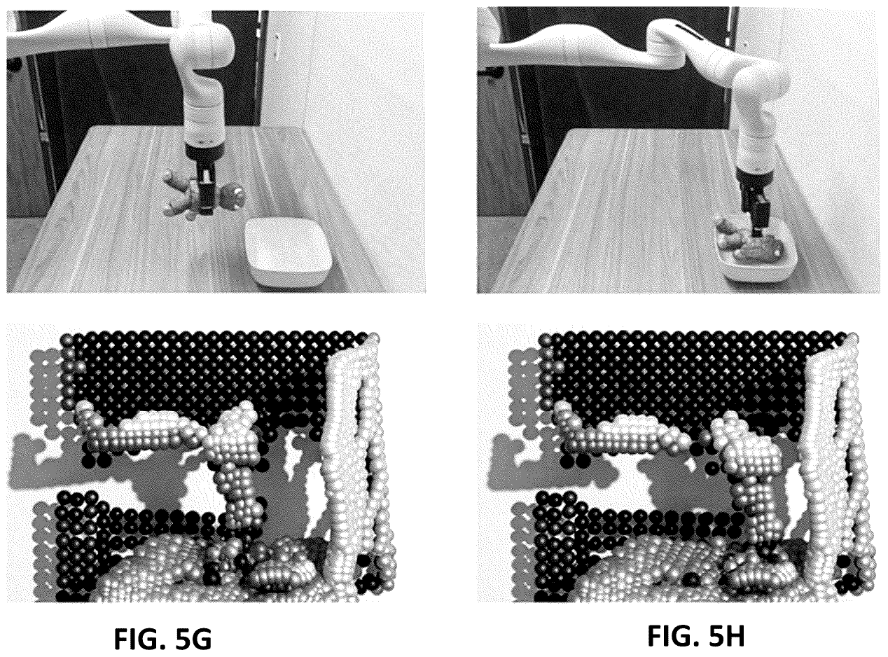

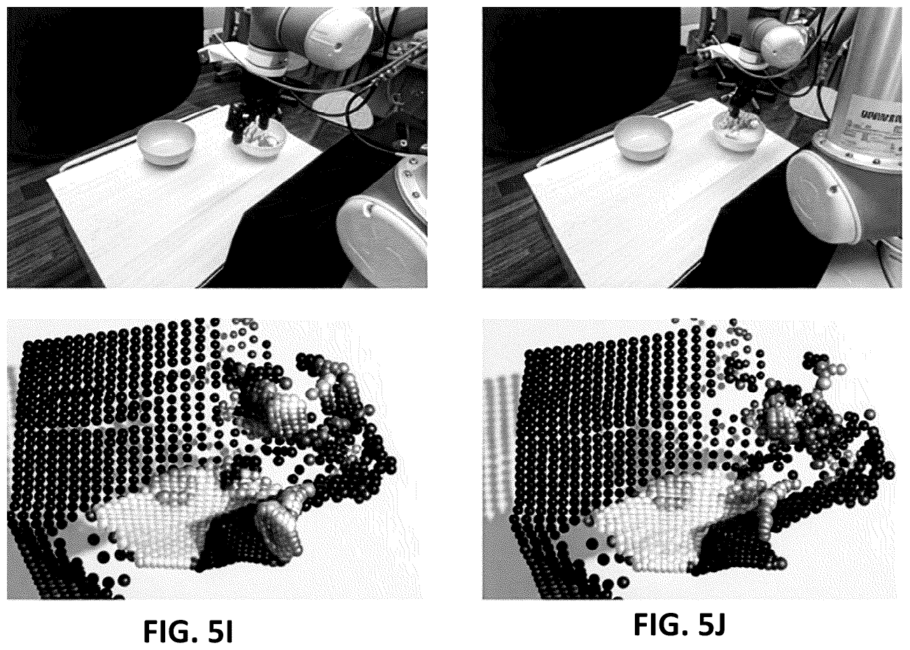

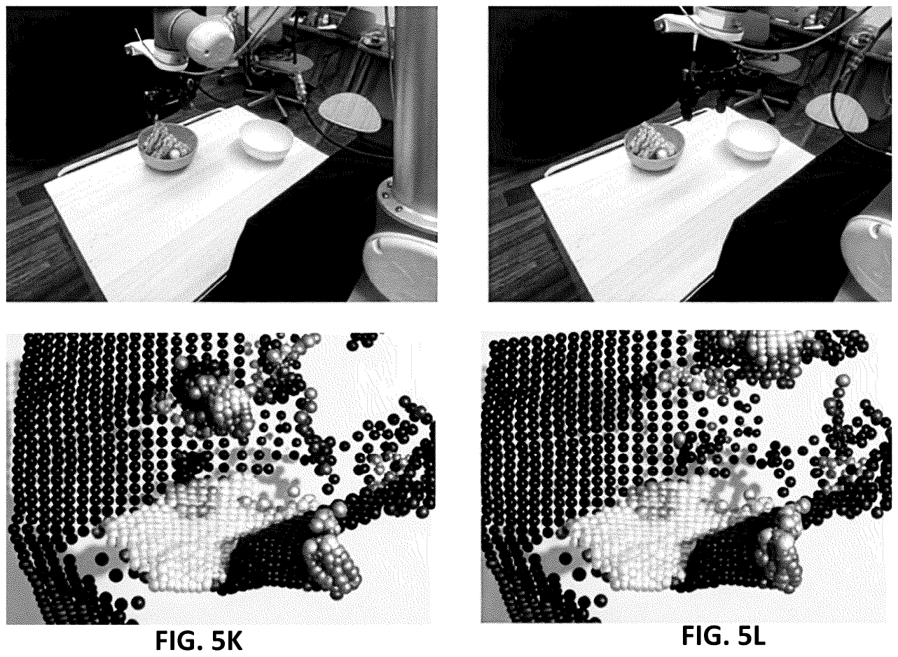

Regarding implementation details, ARM4R was implemented using PyTorch. The implementation used ViT-Base as the vision encoder, which is pretrained as described as described above. The implementation used SpatialTracker as an off-the-shelf 3D point tracker. One should note that the model uses a maximum context window C, which is the number of previous timesteps it considers when predicting the next action. In practice, C=16 was used for most tasks, increasing it to C=32 for some long-horizon tasks, discussed in more detail below regarding FIG. 5. The model is also trained to predict the next 16 actions, but the inventors only executed the first prediction during evaluation. In both simulation and real settings, the implementation used end-effector control, with the model predicting the Cartesian position and rotation of the end-effector, and a binary value for the gripper. Finally, the implementation used 4 NVIDIA A6000 GPUs for training and a single NVIDIA A6000 GPU for evaluation. More information, like training and fine-tuning recipes, is discussed below regarding the implementation, architecture, and training.

Table 1 compares ARM4R's performance against several related baselines on 12 tasks from the RLBench benchmark. The test uses 25 episodes per task and 5 random seeds, averaging the results to get the success rate. ARM4R achieves the best performance on 4 of 12 tasks and the best average success rate. The tasks are: 1—open drawer, 2—meat off grill, 3—turn top, 4—put money, 5—push buttons, 6—sweep dustpan, 7—slide block, 8—close jar, 9—screw bulb, 10—place wine, 11—reach and drag, and 12—stack blocks.

TABLE 1
Success rate (%) on RLBench Multi-Task setting.

| | | | | | | | | | | | | | Avg. |
|---|---|---|---|---|---|---|---|---|---|---|---|---|---|
| | | | | | | | | | | | | | Success |
| | Task | | | | | | | | | | | | Rate |
| Method | 1 | 2 | 3 | 4 | 5 | 6 | 7 | 8 | 9 | 10 | 11 | 12 | (%) |
| Image-BC | 0 | 0 | 16 | 0 | 0 | 0 | 0 | 0 | 16 | 0 | 0 | 0 | 2.67 |
| (ViT) | | | | | | | | | | | | | |
| CSFARM- | 20 | 20 | 68 | 12 | 72 | 0 | 16 | 24 | 8 | 18 | 24 | 4 | 23.83 |
| BC | | | | | | | | | | | | | |
| Mani- | 76 | 60 | 56 | — | 20 | 64 | 24 | 28 | — | — | 92 | 12 | 48.00 |
| Guassian | | | | | | | | | | | | | |
| LLARVA | 60 | 80 | 56 | 44 | 56 | 84 | 100 | 28 | 8 | 12 | 52 | 0 | 48.33 |
| PerAct | 80 | 84 | 80 | 44 | 48 | 56 | 72 | 60 | 24 | 12 | 68 | 36 | 55.33 |
| ARM4R | 88.8 | 94.4 | 61.6 | 92.0 | 67.2 | 72.0 | 85.6 | 24.0 | 10.4 | 36.0 | 77.6 | 4.0 | 59.47 |

Next, the simulation was evaluated. The inventors evaluated ARM4R on 12 RLBench tasks, and follow the settings in PerAct. A task is defined as a collection of demonstrations of the robot interacting in a given scene, with object variations (such as color or size). ARM4R was trained for each task using 190 successful demos for every variation of the task, discussed in more detail below regarding FIG. 5, and evaluated using 25 episodes per task in the validation set. Every episode is scored either 0 for failure or 100 for success. The test used 5 seeds, which are averaged to get the final success rate.

Results were compared to several baselines for the simulation evaluation. Image-BC (ViT) is a 2D language-conditioned baseline model that uses a ViT vision encoder, reported in PerAct. To compare against two different methods that use 3D representations, the test used C2FARM-BC and PerAct, which use voxels as 3D input to calculate robot actions. To compare to a method with 3D temporal tracking similar to the model, it was evaluated against ManiGaussian, which uses a dynamic Gaussian splatting representation to predict robot actions. Lastly, LLARVA is a recent state-of-the-art VLA that directly predicts low-level robot actions given an image and proprioceptive information as part of a language prompt.

The simulation results are reported in Table 1. ARM4R achieves the highest average success rate across all the tasks, and the best success rate for 4 out of 12 tasks. In particular, ARM4R surpasses PerAct, which directly uses voxel information from the simulation environment as input. This approach is not scalable since voxel data is expensive to collect in the real world. Instead, ARM4R learns to model the 3D world by pre-training on 3D point tracking, and the impressive performance highlights the model's strong grasp of physical understanding. One should also note that ARM4R's superior performance compared to LLARVA, which is a VLA which uses a pre-trained language decoder, emphasizes the effectiveness of the representation and pre-training approach.

Real robot experiments were performed using a 7-DoF Kinova Gen3 robot mounted with a Robotiq 2F-85 adaptive gripper. The model of the embodiments and the baselines were tested on 13 total tasks, grouped into five broad categories based on the dominant action: pick, destack, stack, pick and place, and push. For each task, training is performed using 190 episodes of every variation. Evaluation is conducted over 25 episodes per task, with results averaged across three different seeds to calculate the final success rate.

The model of the embodiments was evaluated model against two baselines in real-world settings: ATM and Open-VLA. ATM utilizes a hierarchical framework to predict 2D point trajectories, which are then used to condition a policy. In contrast, ARM4R predicts 3D point trajectories, a more intuitive and natural representation for robotic tasks. OpenVLA, a state-of-the-art 7B-parameter VLA model, is pre-trained on the OpenX dataset, while ARM4R is trained on a significantly smaller dataset, with pre-training consisting exclusively of human video data. This is discussed in more detail below.

Table 2 shows that ARM4R outperforms both baselines across all tasks, achieving an average success rate of 83.1%, compared to OpenVLA's 37.2% and ATM's 6.4%. ATM in particular does not perform well in this real setting despite training with a significantly larger number of demonstrations than used in the fine-tuning. It is believed that this significant gap in performance is due to how the model of the embodiments tracks points: ARM4R utilizes 3D coordinates, while ATM relies on 2D. The use of 3D coordinates provides a more natural and accurate representation for robotic tasks, which may contribute to the model's improved performance.

In contrast to ATM, OpenVLA uses a similar number of fine-tuning episodes to the evaluation setting. However, it is believed that the superior performance of the embodiments over OpenVLA can again be attributed to the use of low-level 4D representations, which enable 3D scene understanding.

Table 2 compares ARM4R's performance to ATM and OpenVLA, two related baselines, on 13 real tasks grouped into five categories. The performance used 25 episodes per task for evaluation, averaging the results over 3 seeds to get the final success rate. ARM4R outperforms both baselines on all the tasks.

TABLE 2
Success rate (%) on the real Kinova Multi-Task setting.

| | | | | | | Stack | |
|---|---|---|---|---|---|---|---|
| | Pick cube up | | | De-stack | | Yellow on | Cyan on |
| Method | Yellow | Cyan | Green | Yellow | Cyan | Cyan | Yellow |
| ATM | 5.3 ± 3.5 | 6.7 ± 2.7 | 9.3 ± 1.3 | 4.0 ± 2.3 | 9.3 ± 3.5 | 1.3 ± 1.3 | 2.6 ± 1.3 |
| OpenVLA | 77.8 ± 6.4 | 45.8 ± 4.2 | 91.7 ± 8.3 | 55.6 ± 2.8 | 51.3 ± 2.6 | 27.8 ± 2.8 | 38.5 ± 4.4 |
| ARM4 | 92.6 ± 3.7 | 100.0 ± 0.0 | 95.8 ± 4.2 | 94.4 ± 2.7 | 94.9 ± 5.1 | 63.6 ± 5.2 | 59.5 ± 2.4 |

| | Pick toys then place to target | | | | Push | | |
|---|---|---|---|---|---|---|---|
| | | | | Play | Red | Red then | |
| Method | Spiderman | Penguin | Pig | basketball | button | blue | Average |
| ATM | 5.3 ± 1.3 | 6.7 ± 1.3 | 5.3 ± 3.5 | 24.0 ± 4.6 | 4.0 ± 2.3 | 0.0 ± 0.0 | 6.4 ± 2.2 |
| OpenVLA | 0.0 ± 0.0 | 17.3 ± 1.3 | 2.7 ± 2.7 | 49.3 ± 3.5 | 23.1 ± 4.4 | 0.0 ± 0.0 | 37.2 ± 3.4 |
| ARM4 | 90.7 ± 1.3 | 94.7 ± 1.3 | 93.3 ± 1.3 | 92.0 ± 2.3 | 84.6 ± 4.4 | 25.0 ± 4.8 | 83.1 ± 3.0 |

Table 3 compares ARM4R to several other robotic models that leverage pre-training on three tasks with a Kinova robot. It was found that the approach of the embodiments yields the best average success rate.

TABLE 3
Pre-training approaches comparison.

| Method | Pick cube | Stack cube | Destack cube |
|---|---|---|---|
| MVP | 75.00 | 18.75 | 81.25 |
| RPT | 87.5 | 31.25 | 93.75 |
| Octo | 56.25 | 12.5 | 37.5 |
| ATM | 7.11 | 2.00 | 6.67 |
| Open VLA | 68.75 | 31.25 | 53.33 |
| LLARVA | 93.75 | 56.25 | 100.00 |
| ARM4R | 96.0 ± 2.3 | 61.3 ± 1.3 | 94.7 ± 1.3 |

The inventors conducted ablations to assess the importance of human video pre-training (Stage 1), and the robotic fine-tuning (Stage 2). All model versions in this section include robotic control fine-tuning (Stage 3). For this, the inventors trained the following versions: (i) Stages 1, 2, and 3; (ii) Stages 1 and 3; (iii) Stages 2 and 3, and (iv) Stage 3 only.

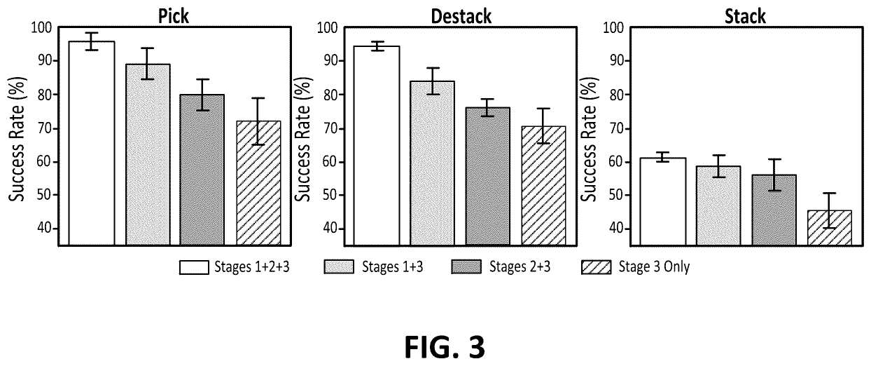

FIG. 3 shows the results of the ablation study. FIG. 3 shows that the model with all stages performs better on all tasks than the Stages 2+3 model, indicating that pre-training on the human dataset provides a large benefit compared to only training for 3D point tracking on robotics videos. The performance boost observed when adding Stage 1 to Stage 3 is greater than the boost from adding Stage 2 to Stage 3, indicating that 4D pre-training on human videos provides a larger increase in performance than robotic videos. The key resulting insight is that when sufficient robotic pre-training data is unavailable, human video data can be a viable alternative, provided the proper 4D representations are used.

The ablation results shown in FIG. 3 reveal that adding robotic video fine-tuning (Stages 2+3; the third column from the left) leads to improved performance over models trained solely for robotic control (Stage 3; the right most column). Adding Stage 2 to the training regime still improves performance, as the model performing all stages (first column) yields the highest success rate. As mentioned above, Stage 2 is useful in addressing the distribution shift and embodiment gap when switching from human to robotic data. The second column from the left is Stages1+3.

The inventors performed additional experiments to evaluate the pre-training effectiveness, and how well the 3D point representations can generalize. More experiments are discussed below regarding Epic Kitchens.

In order to study the effectiveness of pre-training on the 3D point track prediction task, three tasks were taken from the real setting: pick cube, destack cubes, and stack cubes, and compared to other works that use pre-training. MVP focuses on pre-training the vision encoder using human data, while RPT focuses on pre-training with visual and proprioceptive states. Octo, which is a transformer-based policy, is pre-trained on the OpenX dataset, similar to the VLA models LLARVA and OpenVLA. Lastly, ATM pre-trains a 2D point track transformer whose output is used to condition a policy.

The results are shown in Table 3. It can be seen that the pre-training process of the embodiments improves performance over the baselines. ARM4R outperforms other representation learning-based pre-training methods, such as MVP, RPT, Octo and ATM, validating the benefits of using a 4D point-tracking based representation. In addition, while the two VLA baselines (OpenVLA and LLARVA) perform well, the embodiments still surpass their results, possibly demonstrating the importance of using low-level representations as opposed to language decoders that were pre-trained on high-level vision-language tasks.

Generalization from Kinova to Franka. In order to study how the low-level 4D representations can help a model generalize across different robots, the inventors performed an ablation experiment involving fine-tuning ARM4R on Kinova robot videos, and fine-tuning for control on a 7 DoF Franka Emika Panda robot. One should note that besides having different robots, the two setups also have quite different configurations, as the Kinova robot is mounted on a stand as part of a bimanual setup, while the Franka robot is mounted on a table.

TABLE 4
Success rate (%) of ARM4R on cross-robot setting

| Pre-train | FT | Robot | Pick | Stack | Destack |
|---|---|---|---|---|---|
| Epic | Kinova | Kinova | 96..0 ± 2.3 | 61.3 ± 1.3 | 94.7 ± 1.3 |
| — | — | Franka | 73.3 ± 2.7 | 49.3 ± 5.8 | 65.3 ± 3.5 |
| Epic | Kinova | Franka | 93.3 ± 1.3 | 56.0 ± 2.3 | 97.3 ± 1.3 |

Despite these significant differences, the results in Table 4 show that adding the human video pre-training and Kinova video fine-tuning improves the average performance on the Franka robot by 19.6%. This supports that the 4D representations are sufficiently generalizable to transfer across different robotic setups.

The inventors conducted additional experiments to evaluate the pre-trained model's ability to track 3D points. Specifically, inference was run on a few randomly chosen episodes from Epic-Kitchens100 in-domain human videos, Ego4D out-of-domain human videos, Kinova robot videos, in-domain robot videos, and Open X Embodiment, out-of-domain robot videos.

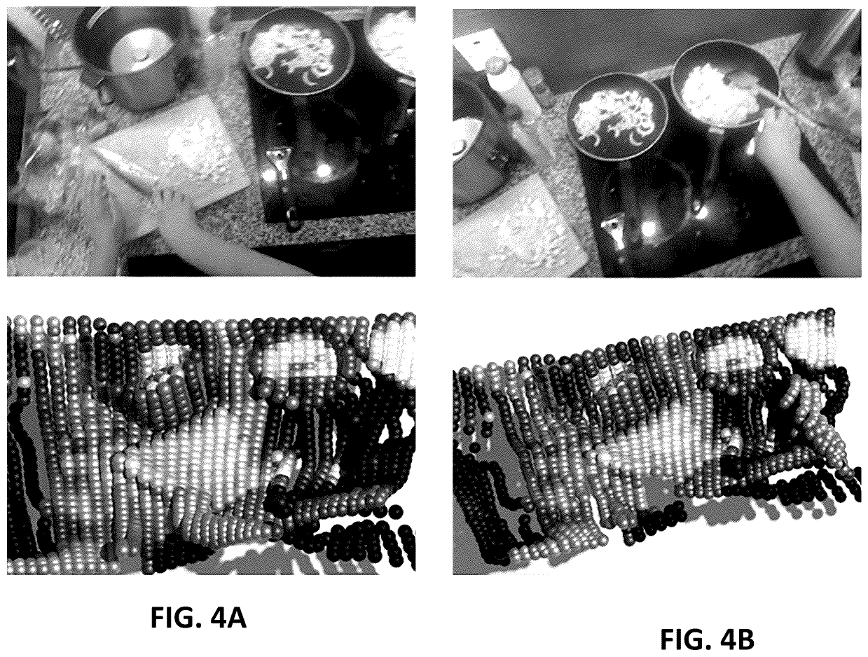

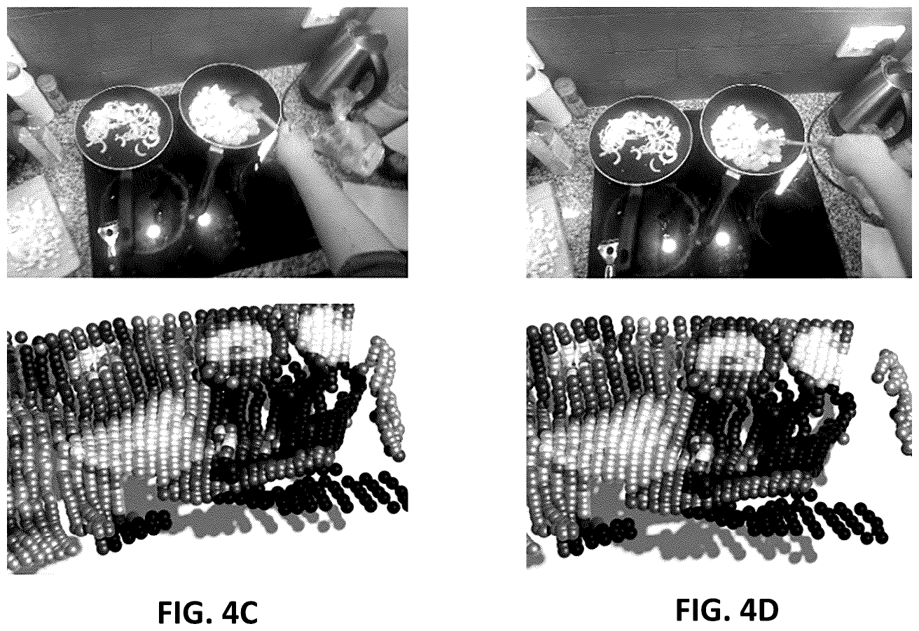

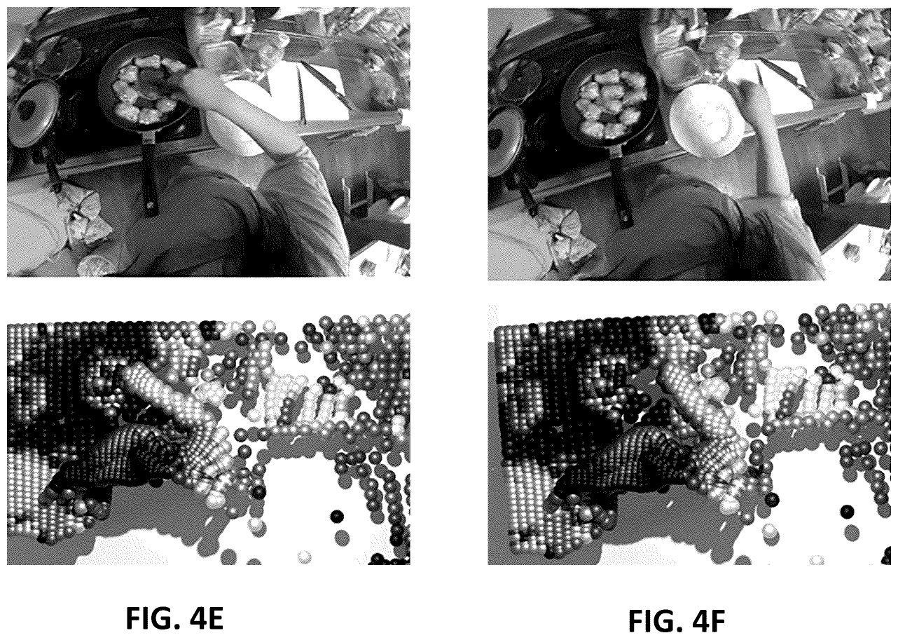

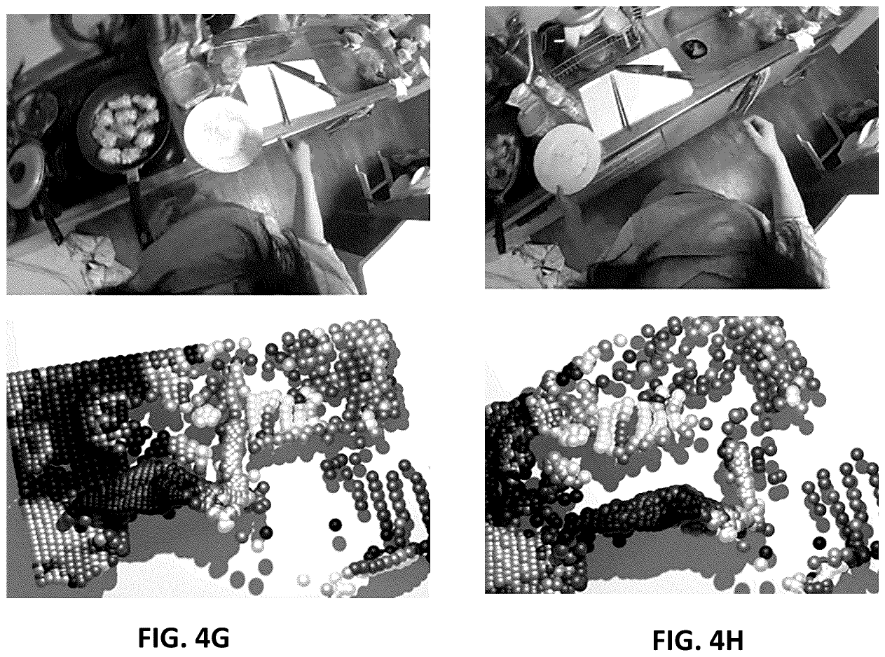

FIGS. 4A-4H present the tracking results on human videos from a version of the model of the embodiments that has undergone human video pre-training (Stage 1). The top rows in FIGS. 4A-4D show the results for an episode from Epic-Kitchens in-domain human videos with the action “stir potatoes,” with the bottom two rows show the 3D point tracking predictions. The top rows of FIGS. 4E-4H display monocular human videos with the bottom rows showing their corresponding 3D point tracking predictions for an episode from Ego-4D out-of-domain human videos with the action “pick up plate,”

FIGS. 5A-5L presents the tracking results on robot videos, from a version of the model that has undergone human video pre-training on Epic-Kitchens100 as well as robot video fine-tuning on Kinova demonstration videos (Stage 1+2). FIGS. 5A-D display monocular robot videos in the top and their corresponding 3D point tracking predictions in the bottom for a first episode from in-domain Kinova robot videos with the action “push red button.” The red button is on the left side of the images. FIGS. 5E-5H show the monocular robot vides in the top and the corresponding 3D point tracking predictions with the action “place spiderman into bowl.” FIGS. 5I-5L shows the results in a similar format for an episode from the Autolab subset of the OpenX Embodiment dataset of out-of-domain robot videos with the action “pick the tiger and place it into bowl.”

These visualizations verify that the model of the embodiments is not overfit to a certain dataset or robotic setup but can in fact generalize well to new videos.

Epic-Kitchens100 is a large-scale, egocentric video dataset designed for action recognition and understanding in daily kitchen activities. Captured from a first-person perspective using head-mounted cameras, the dataset provides rich, untrimmed video recordings of individuals performing various cooking and kitchen-related tasks. It features a diverse range of object interactions, fine-grained action labels, and naturalistic, unscripted activities, making it particularly valuable for studying human-object interactions and long-term temporal dependencies.

The dataset includes diverse hand-object interactions, described by combinations of 97 verbs (for the hand motions) with 300 nouns (for the object categories). In the human video pre-training stage, the process used almost all the labeled episodes available in the original dataset. The videos were first subsampled at 10 fps, an experimentally chosen rate, as the original 50 fps provides unnecessary redundancy for slow movements. The duration distribution of all 75,886 episodes was then modeled and filtered out ≈1% of episodes that are of length >256 frames. This resulted in final set of 75,041 episodes for pre-training. For each episode, the experiment used a simple ‘verb+noun’ instruction derived from the official annotation files.

RLBench is a large-scale benchmark dataset for robotic learning, designed to facilitate research in vision-based reinforcement learning and imitation learning. It consists of a diverse set of robot manipulation tasks performed in a simulated environment using a Franka Emika Panda arm. The dataset provides high-quality demonstrations with multi-modal observations, including RGB images, depth maps, and proprioceptive data.

The experiments used 128×128 resolution images for training. Most tasks used the ‘front rgb’ and ‘wrist rgb’ views for point track and control fine-tuning. However, in some cases, it was found that using other views yields better performance (details on task-specific implementations are provided in below). For robot control, the experiment used end-effector control: x=(x, y, z, θₓ, θ_{y}, θ_{z}), where (x, y, z) is the position and (θₓ, θ_{y}, θ₂) are the Euler angles for orientation. There is also a one-dimensional binary element to control the gripper. For language instructions, the experiments used variation 0 from the official list of instructions for all tasks. The experiments do not subsample episodes.

This portion of the discussion provides additional implementation details and the architecture of the model of the embodiments. It provides details on processing the visual input of the auto-regressive model to support two views when adapting to robot control fine-tuning. The images from both views are fed separately into the image encoder to obtain the image embeddings

$${z}_{t}^{im}$$

for each view. Each view is then pooled using attention pooling with the state embeddings to form the image tokens

$${z}_{t}^{o b s} .$$

Next, each token is projected to half of its original hidden dimension (768→384 in the implementation and concatenated to obtain the final mage tokens, incorporating information from both views.

For training recipes, the experiments used the following hyperparameters for the three stages of training.

TABLE 5
Training Hyperparameters for the three stages.

| Hyperparameter | Stage 1 | Stage 2 | Stage 3 |
|---|---|---|---|
| Learning Rate | 5 × 10⁻⁴ | 5 × 10⁻⁴ | 5 × 10⁻³ |
| Weight Decay | 1 × 10⁻² | 1 × 10⁻² | 1 × 10⁻² |
| Batch Size | 256 | 256 | 256 |
| Number of Epochs | 5 | 20 | 10-50 |

One should note that for Stage 3, the model of the embodiments was trained for a variable number of epochs depending on the downstream task, until the loss converged.

The inventors evaluated the model on 12 tasks in RLBench for the simulation setup. Each task includes multiple variations, and 190 episodes were generated using their data generation script for ARM4R training. Most cases followed the task setup of PerAct (Shridhar et al., 2023) and used the ‘front rgb’ and ‘wrist rgb’ views. The context window of the auto-regressive model used C=16. The detailed task-level configuration is provided below.

One task is to open one of three drawers. The success metric is a full extension of the prismatic joint of the target drawer. The experiment used the ‘front rgb’ and ‘wrist rgb’ views. The context window of the model is C=16.

Another task is to take meat, either a piece of chicken or steak, off the grill and put it on the side. The success metric is the placement of the specified meat on the side, away from the grill. The experiment used the ‘front rgb’ and ‘wrist rgb’ views. The context window of the model is C=16.

Another task is to turn either the left or right handle of the tap. Left and right are defined according to the orientation of the faucet. The success metric is the joint of the specified handle being at least 90° away from the starting position. The experiment uses the ‘front rgb’ and ‘wrist rgb’ views. The context window of the model is C=16.

Another task is to “put money” by picking up the stack of money and placing it on the specified shelf of a safe. The safe has three shelves: top, middle, and bottom. The success metric is the placement of the stack of money on the specified shelf in the safe. The experiment used the ‘front rgb’ and ‘overhead rgb’ views. The context window of the model is C=16.

The Push Button task is to push the colored buttons in the specified sequence. There are always three buttons present in the scene, whose colors are sampled from 20 options, and the number of buttons to press is between one and three. The success metric is all specified buttons being pressed in the right order. The experiment used the ‘front rgb’ and ‘wrist rgb’ views. The context window of the model is C=32.

The Sweep Dustpan task is to sweep the dirt particles into the specified dustpan. There are two dustpans, one short and one tall, and both are always present in the scene. The success metric is all five dirt particles being inside the specified dustpan. This task was modified by adding a variation with a different-sized dustpan. The experiment used the ‘front rgb’ view only, repeated twice, for this task. The context window of the model is C=16.

Another task is to slide a block, where there are a block and four colored squares in the scene (green, blue, pink, and yellow). The task is to slide the block onto either the green or pink squares. The success metric used is some part of the block being on the specified target square. The original task only had one target square and was modified by adding three additional colored squares—one target and two distractors. The experiment used the ‘front rgb’ view only, repeated twice, for this task. The context window of the model is C=16.

Another task is to screw in the lid on the jar with the specified color. There are always two colored jars in the scene, one target jar and one distractor jar. The success metric used is the lid being on top of the specified jar and the robot gripper not grasping any object. This task was modified so that the target jar color is drawn from a list of three possible colors (red, maroon, and lime). The color for the distractor jar was still chosen out of 20 options. The experiment used the ‘front rgb’ and ‘wrist rgb’ views. The context window of the model is C=32.

Another task is Screw Bulb. There are two bulb holders of different colors, and the task is to pick up a light bulb from the stand specified by color and screw it into the bulb stand. The color of the target holder is sampled from two colors, while the color of the distractor holder is sampled from the original 20 color options. The success metric used is the bulb from the specified holder being inside the bulb stand. This task was modified to use three colors for the target holder (yellow, purple, and silver) rather than 20 as in the original task specification. The experiment used the ‘front rgb’ and ‘wrist rgb’ views. The context window of the model is C=16.

Another task is to pick up a wine bottle and place it at the specified location in a wooden rack. The rack has three locations: left, middle, and right. The success metric is the placement of the bottle on the specified location in the rack. The experiment used the ‘front rgb’ and ‘wrist rgb’ views. The context window of the model is C=16.

Another task is Reach and Drag. The environment has a cube, a stick, and four possible colored target squares. The task is to pick up the stick and use it to drag the cube to the target square of a specified color. The other three squares are considered distractors. The success metric used is some part of the block being inside the target's area. This task was modified to sample the target color from a list of three colors (maroon, magenta, teal). The colors for distractor squares are still sampled from 20 options. The experiment used the ‘front rgb’ and ‘wrist rgb’ views. The context window of the model is C=16.

Another task is Stack Blocks. The scene starts with 8 blocks and a green platform. Four of the blocks are of a target color, and the other four have a distractor color. The task is to stack N blocks of the target color on the green platform. The success metric is N blocks being inside the area of the green platform. The experiment used the ‘front rgb’ and ‘wrist rgb’ views. The context window of the model is C=16.

Baselines were used for the experiments. The inventors reproduced ATM as a baseline for the Kinova real-world experiment setup, following the provided code and instructions. In the first stage, the experiment used all Kinova robot episodes (5 tasks, each with 200 episodes per variation) to train a track transformer using ground truth point tracks generated by Co-Tracker. In the second stage, the inventors took the best checkpoint of the track transformer to train a policy for each task separately, consistent with ARM4R's real-world setup. ATM uses a 7-dimensional joint pose and one-dimensional gripper state in its policy. To adapt it to the desired data format, the implementation was modified to end-effector control, predicting a 3-dimensional (x, y, z) position, a 4-dimensional quaternion rotation, and a 1-dimensional gripper state.

The inventors also tested OpenVLA on the Kinova robot setup, following their fine-tuning code and instructions. The inventors fine-tuned OpenVLA using LoRA (Hu et al., 2021), with rank 32 and a batch size of 16, training until convergence. To adapt OpenVLA to the desired control setting, the inventors converted the absolute proprioceptive states to 3-dimensional delta position and 3-dimensional delta rotation (Euler angles), with an additional binary gripper dimension. The original collected data was subsampled at a ratio of 10, since the difference between consecutive steps in the original data is too small for delta control, given the accuracy limit of OpenVLA (10-3).

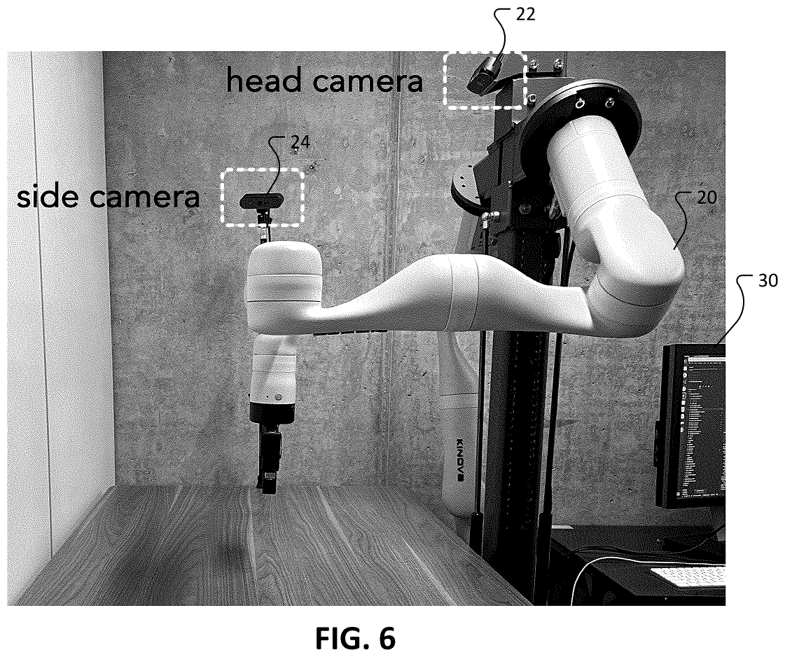

The primary real-world experiments, used a Kinova Gen3 7 DoF manipulator with a Robotiq 2F-85 gripper, as shown in FIG. 6. It is mounted on a base that mimics the human shoulder orientation and height. One should note that the robots in these images are robotic arms, the resulting model applies to any robotic motion. In FIG. 6, the robot 20 has one or more processors configured to execute the invention as claimed, and the robotic system comprises the robot and the ARM4R model. The embodiments may comprise one or more processors performing the training and operating the robot. The processors may reside in the robot 20, in the computing device 30, or the processes may occur partially on one or more processors in the robot and one or more processors in the computing device. For example, without limitation, the stage 1 and stage 2 training may occur on the computing device, and stage 3 may occur on the robot. Alternatively, all three stages may occur on the robot, or all three stages may occur on the computing device. The partially trained model, meaning through stage 1 alone, or stages 1 and 2, may be installed into the robot for stage 3, which could be through some network connection, or the model may operate on the computing device and send commands to the robot, where the model does not reside on the robot.

Two cameras (Logitech BRIO 4K camera) were set up to observe the table-top manipulation scene. One camera 22 is mounted at an egocentric pose, and the other camera 24 is mounted on the side of the table.

The experiment used the MoveIt motion planning framework for inverse kinematics and end-effector position control. It takes the end effector position objective from the model and executes linear trajectories in the Cartesian space.

To collect task demonstrations data, an automated data collection procedure was developed to record episodes of these demonstrations. In this procedure, the process gives the ground truth locations of all objects on the table, and procedurally generate task objectives, demonstrations, and accompanying task instruction labels. Domain randomization is applied to diversify robot home position, grasping approach trajectory, and target pose.

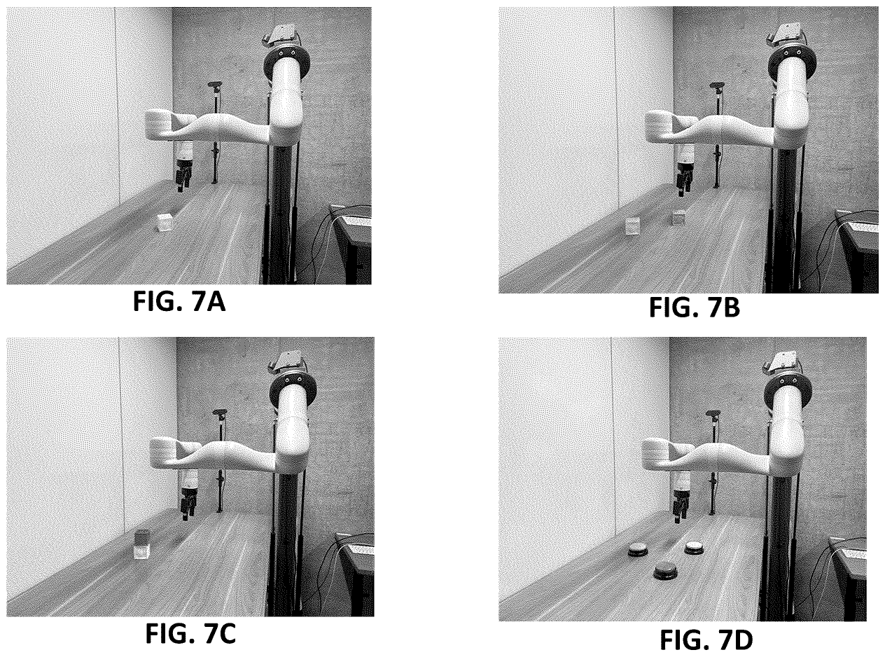

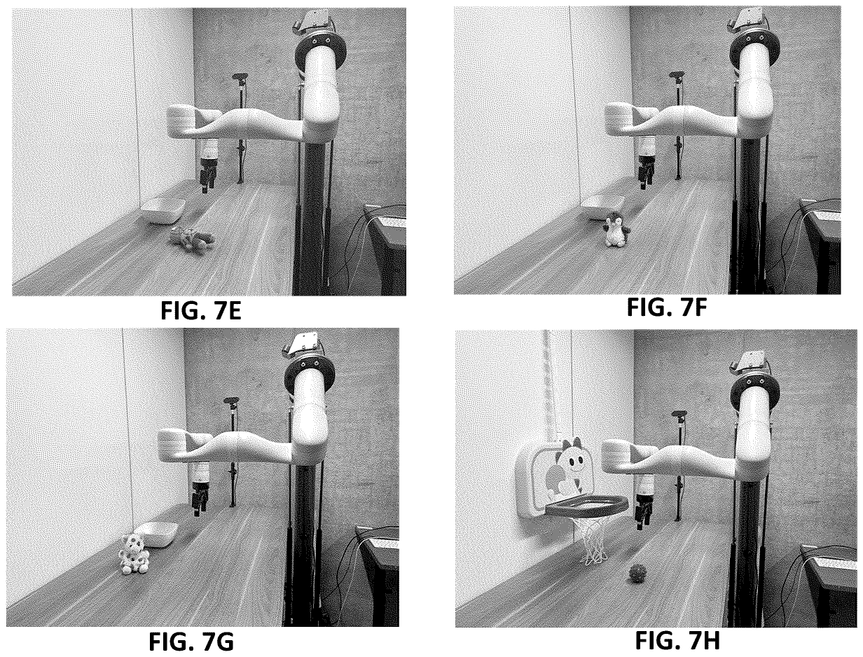

The inventors built 5 tasks under the Kinova real robot setup. The configuration of each task and its variations are shown in FIGS. 7A-7H. The details of each task are described as follows.

An episode on picking cubes shown in FIG. 7A starts with the arm in the home position. The robot moves to pick up the cube, placed at a random location on the table within the manipulator's workspace. The episode recording stops after the robot picks up the object and moves up by a certain distance.

An episode on stacking cubes shown in FIG. 7B starts with the arm in the home position. After picking up the cube from point A as in the pick cube task, the robot stacks it on another object already present in the scene at point B according to the instruction. The episode recording stops after the robot releases the object and moves up by a certain distance.

An episode on destacking cubes shown in FIG. 7C starts with the arm in the home position. After picking up the top cube from a stacked pair at point A as in the grasping task, the robot moves the grasped cube to another location, point B. The episode recording stops after the robot releases the object and moves up by a certain distance.

One task involved push buttons shown in FIG. 7D. The episode starts with the arm in the home position. Following the instruction, the arm moves to a specific height above the assigned button at point A, closes the gripper, pushes the button, then moves to push another button at point B. The episode recording stops after the robot releases the object and moves up by a certain distance.

An episode involving pick and place toys/basketball shown in FIGS. 7E-7G starts with the arm in the home position. After picking up the toy described in the instruction from point A, the robot moves and places the toy into a bowl or basket at point B. The episode recording stops after the robot releases the object and moves up by a certain distance.

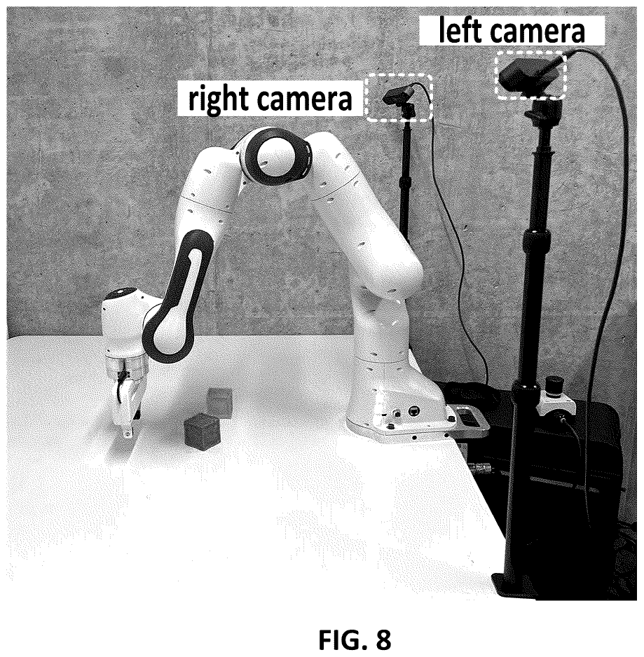

A real-world experiment used a Franka Emika Panda robot with a Franka gripper for real robot data collection and evaluations. The Logitech BRIO 4K cameras positioned to the left and right of the Franka robot provides double-view RGB (without depth data) vision input to the model, as shown in FIG. 8. Camera autofocus is disabled, and the data is captured at 640×480 resolution.

The experiments used the data collection code and process from https://github.com/Max-Fu/franka-scripted to collect data for automated tasks. The script generates data for an arbitrary number of episodes. For each episode, the process generates x-y positions on the table plane using a uniform random distribution for each axis. The script directs the robot to place the object at each location and then collects the camera and joint information as the robot is moving.

Task building involved building cube tasks under the Franka real robot setup. The configurations of each task and its variations are shown in FIG. 8. The details of each task are described as follows.

One episode was Pick Cube. The episode starts with the arm in the home position. The robot moves to pick up the cube from point A. The episode recording stops after the robot picks up the object and moves up by a certain distance.

Another episode is Stack Cubes. The episode starts with the arm in the home position. After picking up the cube from point A as in the grasping task, the robot stacks it on another object already present in the scene at point B according to the instruction. The episode recording stops after the robot releases the object and moves up by a certain distance.

Another episode is Destack Cubes. The episode starts with the arm in the home position. After picking up the top cube from a stacked pair at point A as in the grasping task, the robot moves the grasped cube to another location, point B. The episode recording stops after the robot releases the object and moves up by a certain distance.

The embodiments herein demonstrate that the pre-training approach from human video data to robot learning is effective in addressing longstanding challenges of robotic learning pre-training. The embodiments introduced ARM4R, an Auto-regressive Robotic Model that leverages low-level 4D representations by lifting 2D representations into 3D using monocular depth estimators and tracking 3D points in videos. the results in simulation and real-world setups show that the methods disclosed herein consistently outperforms existing methods across diverse robotic tasks, showcasing the model superior transferability and generalization capabilities. More broadly, the embodiments show that training solely on human video data can lead to better performance than methods like OpenVLA that are pre-trained on robotic data alone. This suggests that effective pre-training can be achieved without the need for large-scale robotic datasets by bridging the gap between human-centric visual data and robotic applications, unlocking new possibilities for scalable and data-efficient robotics.

Additionally, this written description makes reference to particular features. It is to be understood that the disclosure in this specification includes all possible combinations of those particular features. For example, where a particular feature is disclosed in the context of a particular aspect, that feature can also be used, to the extent possible, in the context of other aspects.

Also, when reference is made in this application to a method having two or more defined steps or operations, the defined steps or operations can be carried out in any order or simultaneously, unless the context excludes those possibilities.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although specific aspects of this disclosure have been illustrated and described for purposes of illustration, it will be understood that various modifications may be made without departing from the spirit and scope of the invention. Accordingly, the invention should not be limited except as by the appended claims.

1. A robotic system, comprising:
a robot;
one or more processors configured to execute code that cause the one or more processors to:
estimate four-dimensional representations from videos;
operate a machine learning transformer model to use information from the four-dimensional representation for training a policy for predicting a next action for the robot; and
use the machine learning transformer model with the robot.

2. The robotic system as claimed in claim 1, wherein the code that causes the one or more processors to estimate four-dimensional representations comprises code that causes the one or more processors to:
to generate three-dimensional (3D) points from the videos; and
tracking the 3D points across time.

3. The robotic system as claimed in claim 2, wherein the code that causes the one or more processors to generate the 3D points from the videos comprises code that causes the one or more processors to apply monocular depth estimation to the videos to generate the 3D points.

4. The robotic system as claimed in claim 2, wherein the code that causes the one or more processors to use a regressive model to generate the 3D points.

5. The robotic system as claimed in claim 2, wherein the code that causes the one or more processors to generate the 3D points across time comprises code that causes the one or more processors to:
find 3D coordinates of a set of 3D points;
provide unique identities for all the 3D points in the set; and
track the 3D coordinates of the 3D points in the set through the video using the unique identities.

6. The robotic system as claimed in claim 1, wherein the code that cause the one or more processors to operate the machine learning transformer model comprises code to cause the one or more processors to operate an auto-regressive model that receives inputs of a given time step and predicts a next state of the robot.

7. The robotic system as claimed in claim 6, wherein the given time step is one of a set of timesteps in a content window of a predetermined number of timesteps for predicting the next state of the robot.

8. The robotic system as claimed in claim 6, wherein the code that cause the one or more processors to operate the auto-regressive model comprises code to receive inputs of a language instruction, an image input, and a current 3D coordinate of points tracked across the videos over time, the videos comprising human videos, and generate an output that predicts future coordinates of the 3D coordinates of the tracked 3D points.

9. The robotic system as claimed in claim 8, wherein the one or more processors are further configured to execute code that causes the one or more processors to receive inputs of a second language instruction, a second image input, and a current coordinate of the 3D coordinate of points in videos over time, the videos comprising robot videos, to predict a next state of the robot.

10. The robotic system as claimed in claim 9, wherein a fewer number of robot videos are used to predict the next state of the robot than in the robotic videos and the human videos.

11. The robotic system as claimed in claim 1, wherein the one or more processors are further configured to determine loss based only upon the next action predicted for the robot.
